(19) United States
(12) Patent Application Publication
(10) Pub. No.: US 2006/0045134 A1
(43) Pub. Date: Mar. 2, 2006

(54) Ultra-wideband synchronization systems and methods

(76) Inventors: John Eldon, Encinitas, CA (US); John Santhoff, Carlsbad, CA (US); Steven Moore, Escondido, CA (US)

Correspondence Address: PULSE-LINK, INC., 1969 KELLOGG AVENUE, CARLSBAD, CA, 92008, US

(21) Appl. No.: 10/925,469

(22) Filed: Aug. 25, 2004

(51) Int. Cl. H04J 3/06

(52) U.S. Cl. 370/503

(57) ABSTRACT

The present invention provides systems and methods for ultra-wideband communication devices to maintain synchronization. One embodiment of the present invention provides a method by which ultra-wideband communication devices may update their timing references by the use of a statistics register. In another embodiment, a network of ultra-wideband communication devices uses the statistics registers of a plurality of ultra-wideband devices to update their timing references based on calculating a function. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention generally relates to ultra-wideband communications. More particularly, the invention concerns synchronization of Ultra-wideband devices.

### BACKGROUND OF THE INVENTION

The Information Age is upon us. Access to vast quantities of information through a variety of different communication systems are changing the way people work, entertain themselves, and communicate with each other. For example, as a result of increased telecommunications competition mapped out by Congress in the 1996 Telecommunications Reform Act, traditional cable television program providers have evolved into full-service providers of advanced video, voice and data services for homes and businesses. A number of competing cable companies now offer cable systems that deliver all of the just-described services via a single broadband network.

These services have increased the need for bandwidth, which is the amount of data transmitted or received per unit time. More bandwidth has become increasingly important, as the size of data transmissions has continually grown. Applications such as in-home movies-on-demand and video teleconferencing demand high data transmission rates. Another example is interactive video in homes and offices. The emergence of the Internet saw the largest impact on the telecommunication networks by bringing about the convergence of voice and Internet data traffic. Consequently, carriers and service providers are overhauling the entire network infrastructure—including switches, routers, backbone, and the last mile (i.e., the local loop)—in an effort to provide more bandwidth.

Other industries are also placing bandwidth demands on Internet service providers, and other data providers. For example, hospitals transmit images of X-rays and CAT scans to remotely located physicians. Such transmissions require significant bandwidth to transmit the large data files in a reasonable amount of time. The need for more bandwidth is evidenced by user complaints of slow Internet access and dropped data links that are symptomatic of network overload.

The wireless device industry has recently seen unprecedented growth. With the growth of this industry, communication between wireless devices has become increasingly important. There are a number of different technologies for inter-device communications. Radio Frequency (RF) technology has been the predominant technology for wireless device communications. Alternatively, electro-optical devices have been used in wireless communications. Electro-optical technology suffers from low ranges and a strict need for line of sight. RF devices therefore provide significant advantages over electro-optical devices.

Conventional RF technology employs continuous sine waves that are transmitted with data embedded in the modulation of the sine waves' amplitude or frequency. For example, a conventional cellular phone must operate at a particular frequency band of a particular width in the total frequency spectrum. Specifically, in the United States, the Federal Communications Commission has allocated cellular phone communications in the 800 to 900 MHz band. Generally, cellular phone operators divide the allocated band into 25 MHz portions, with selected portions transmitting cellular phone signals, and other portions receiving cellular phone signals.

Another type of inter-device communication technology is ultra-wideband (UWB). UWB wireless technology is fundamentally different from conventional forms of RF technology. UWB employs a “carrier free” architecture, which does not require the use of high frequency carrier generation hardware; carrier modulation hardware; frequency and phase discrimination hardware or other devices employed in conventional frequency domain communication systems.

A number of architectures for use of ultra wideband communications have been suggested. In one approach the frequency spectrum allocated to UWB communications devices is partitioned into bands of more limited space. Modulation techniques and wireless channelization schemes can then be designed around a UWB device operating within one or more of these sub-bands. Alternatively, a UWB communications device may occupy all or substantially the entire allocated spectrum. Additionally, some modulation techniques may require the generation of UWB pulses at specific amplitudes and or phases. All of these approaches require a UWB device to generate specific pulse morphology to conform to the desired architecture.

Therefore, there exists a need for a method to increase the bandwidth of wireless and wired communication networks.

### SUMMARY OF THE INVENTION

The present invention provides systems methods of synchronization for devices and networks that employ ultra-wideband (UWB) technology. In one embodiment of the present invention, a UWB device transmits a communication frame to a receiving device. The receiving device synchronizes its timing reference to the incoming signal at the beginning of each frame. The receiving device maintains the time of arrival of the synchronization sequence relative to its expected time of arrival in a statistics register. After storing a number of synchronization arrival signals, it reports the statistics to the first device. The first device may then adjust its timing reference to better match the receiving device.

One feature of the present invention is that with improved accuracy of the timing references, the need for periodic re-synchronization is reduced. Since synchronization sequences impart no data, they constitute overhead in a communications link. Therefore, reducing periodic re-synchronization can increase actual data throughput.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is an illustration of different communication methods;

FIG. 2 is an illustration of two ultra-wideband pulses;

FIG. 3 illustrates time bin adjustment consistent with one embodiment of the present invention;

FIG. 4 illustrates relative clock drift between devices;

FIG. 5 illustrates a network of communications devices;

FIG. 6 shows one method of the present invention; and

FIG. 7 shows another method of the present invention.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Modern wireless communications devices, such as devices that employ UWB technology, have to reliably discriminate signal or pulse timing to very precise levels. This is because a transmitter usually encodes information on the signal using precise time intervals. A receiver generally decodes the information from the received signal by synchronizing its timing to approximate the internal clock timing of the transmitter. Since there may be instability or drift in clock reference circuits, the transmitting and receiving devices need to be periodically re-synchronized. This periodic re-synchronization adds additional overhead to the communications link between devices, thereby negatively impacting the data rate.

The present invention provides methods of ultra-wideband (UWB) synchronization. In most forms of UWB communications Time Division Multiple Access (TDMA) is employed. In UWB-TDMA a master device will allocate a period of time known as a frame. Within the frame there are a number of time slots. The master device usually transmits a frame synchronization at the beginning of the frame. There may be time slots allocated for control information, contention based time slots, and time slots dedicated to each device within the network, referred to as user time slots. Each of these time slots may comprise a number of symbol slots where UWB pulses may be located.

Generally, a master device allocates and assigns the user time slots to individual devices within a network. At the beginning of each user time slot, the transmitting device may transmit its own synchronization sequence, followed by other header information, the data to be sent, and potentially a trailer or postamble that may contain other information usually relating to error detection and correction. A receiving UWB communication device adjusts its timing reference to an incoming signal generally found at the beginning of each frame. This adjustment, known as synchronization, allows the receiving device to align its time bins according to the transmitting devices time bins. Once the time bins are aligned the receiving device may demodulate data from the incoming signal.

In one embodiment of the present invention, the receiving device stores the time of arrival of the synchronization sequence relative to its expected time of arrival in a register such as a statistics register. After storing a number of synchronization arrival signals, it reports the statistics to the transmitting device. The transmitting device may then adjust its timing reference to better match the receiving device. Alternatively, the receiving device may use the contents of the statistics register to further adjust its timing reference.

One feature of the present invention is that with improved accuracy of the timing references, the need for periodic re-synchronization is reduced. Since synchronization sequences impart no data, they constitute overhead in a communications link. Therefore, reducing periodic re-synchronization can increase actual data throughput.

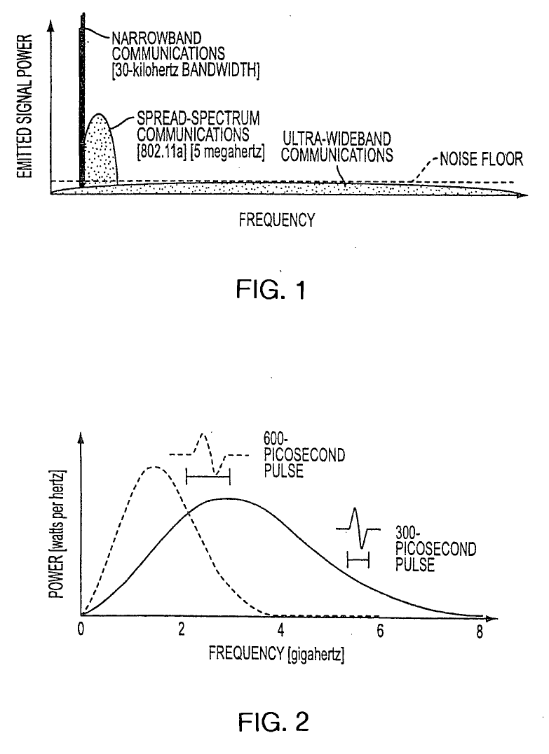

Referring to FIGS. 1 and 2, ultra-wideband (UWB) communication employs discrete pulses of electromagnetic energy that are emitted at, for example, nanosecond or picosecond intervals (generally tens of picoseconds to a few nanoseconds in duration). For this reason, ultra-wideband is often called “impulse radio.” That is, the UWB pulses may be transmitted without modulation onto a sine wave, or a sinusoidal carrier, in contrast with conventional carrier wave communication technology. UWB generally requires neither an assigned frequency nor a power amplifier.

Alternate embodiments of UWB may be achieved by mixing baseband pulses (i.e., information-carrying pulses), with a carrier wave that controls a center frequency of a resulting signal. The resulting signal is then transmitted using discrete pulses of electromagnetic energy, as opposed to transmitting a substantially continuous sinusoidal signal.

An example of a conventional carrier wave communication technology is illustrated in FIG. 1. IEEE 802.11a is a wireless local area network (LAN) protocol, which transmits a sinusoidal radio frequency signal at a 5 GHz center frequency, with a radio frequency spread of about 5 MHz. As defined herein, a carrier wave is an electromagnetic wave of a specified frequency and amplitude that is emitted by a radio transmitter in order to carry information. The 802.11 protocol is an example of a carrier wave communication technology. The carrier wave comprises a substantially continuous sinusoidal waveform having a specific narrow radio frequency (5 MHz) that has a duration that may range from seconds to minutes.

In contrast, an ultra-wideband (UWB) pulse may have a 2.0 GHz center frequency, with a frequency spread of approximately 4 GHz, as shown in FIG. 2, which illustrates two typical UWB pulses. FIG. 2 illustrates that the shorter the UWB pulse in time, the broader the spread of its frequency spectrum. This is because bandwidth is inversely proportional to the time duration of the pulse. A 600-picosecond UWB pulse can have about a 1.8 GHz center frequency, with a frequency spread of approximately 1.6 GHz and a 300-picosecond UWB pulse can have about a 3 GHz center frequency, with a frequency spread of approximately 3.3 GHz. Thus, UWB pulses generally do not operate within a specific frequency, as shown in FIG. 1. Either of the pulses shown in FIG. 2 may be frequency shifted, for example, by using heterodyning, to have essentially the same bandwidth but centered at any desired frequency. And because UWB pulses are spread across an extremely wide frequency range, UWB communication systems allow communications at very high data rates, such as 100 megabits per second or greater. Further details of UWB technology are disclosed in U.S. Pat. No. 3,728,632 (in the name of Gerald F. Ross, and titled: Transmission and Reception System for Generating and Receiving Base-Band Duration Pulse Signals without Distortion for Short Base-Band Pulse Communication System), which is referred to and incorporated herein in its entirety by reference.

Also, because the UWB pulses are spread across an extremely wide frequency range, the power sampled in, for example, a one megahertz bandwidth is very low. For example, UWB pulses of one nano-second duration and one-milliwatt average power (0 dBm) spreads the power over the entire one-gigahertz frequency band occupied by the pulse. The resulting power density is thus 1 milliwatt divided by the 1,000 MHz pulse bandwidth, or 0.001 milliwatt per megahertz (−30 dBm/MHz). This is below the signal level of any wire media system and therefore does not interfere with the demodulation and recovery of signals transmitted by the CATV provider.

Generally, in the case of wireless communications, a multiplicity of UWB pulses may be transmitted at relatively low power density (milliwatts per megahertz). However, an alternative UWB communication system may transmit at a higher power density. For example, UWB pulses may be transmitted between 30 dBm to −50 dBm. UWB pulses, however, transmitted through many wire media will not interfere with wireless radio frequency transmissions. Therefore, the power (sampled at a single frequency) of UWB pulses transmitted though wire media may range from about +30 dBm to about −140 dBm.

The present invention may be employed in any type of network, be it wireless, wire, or a mix of wire media and wireless components. That is, a network may use both wire media, such as coaxial cable, and wireless devices, such as satellites, or cellular antennas. As defined herein, a network is a group of points or nodes connected by communication paths. The communication paths may use wires or they may be wireless. A network as defined herein can interconnect with other networks and contain sub-networks. A network as defined herein can be characterized in terms of a spatial distance, for example, such as a local area network (LAN), a personal area network (PAN), a metropolitan area network (MAN), a wide area network (WAN), and a wireless personal area network (WPAN), among others. A network as defined herein can also be characterized by the type of data transmission technology used by the network, such as, for example, a Transmission Control Protocol/Internet Protocol (TCP/IP) network, a Systems Network Architecture network, among others. A network as defined herein can also be characterized by whether it carries voice, data, or both kinds of signals. A network as defined herein may also be characterized by users of the network, such as, for example, users of a public switched telephone network (PSTN) or other type of public network, and private networks (such as within a single room or home), among others. A network as defined herein can also be characterized by the usual nature of its connections, for example, a dial-up network, a switched network, a dedicated network, and a non-switched network, among others. A network as defined herein can also be characterized by the types of physical links that it employs, for example, optical fiber, coaxial cable, a mix of both, unshielded twisted pair, and shielded twisted pair, among others.

The present invention may be employed in any type of wireless network, such as a wireless PAN, LAN, MAN, or WAN. In addition, the present invention may be employed in wire media, as the present invention dramatically increases the bandwidth of conventional networks that employ wire media, yet it can be inexpensively deployed without extensive modification to the existing wire media network.

Several different methods of ultra-wideband (UWB) communications have been proposed. For wireless UWB communications in the United States, all of these methods must meet the constraints recently established by the Federal Communications Commission (FCC) in their Report and Order issued Apr. 22, 2002 (ET Docket 98-153). Currently, the FCC is allowing limited UWB communications, but as UWB systems are deployed, and additional experience with this new technology is gained, the FCC may expand the use of UWB communication technology.

The April 22 Report and Order requires that UWB pulses, or signals occupy greater than 20% fractional bandwidth or 500 megahertz, whichever is smaller. It will be appreciated that the FCC definition of UWB may change, and that the present invention applies to all UWB communications, however defined. Fractional bandwidth is defined as 2 times the difference between the high and low 10 dB cutoff frequencies divided by the sum of the high and low 10 dB cutoff frequencies. Specifically, the fractional bandwidth equation is:

$$Fractional Bandwidth = 2 \frac{{f}_{h} - {f}_{l}}{{f}_{h} + {f}_{l}}$$

where fₕ is the high 10 dB cutoff frequency, and f, is the low 10 dB cutoff frequency.

Stated differently, fractional bandwidth is the percentage of a signal's center frequency that the signal occupies. For example, a signal having a center frequency of 10 MHz, and a bandwidth of 2 MHz (i.e., from 9 to 11 MHz), has a 20% fractional bandwidth. That is, center frequency, fc=(fₕ+f₁)/2

Communication standards committees associated with the International Institute of Electrical and Electronics Engineers (IEEE) are considering a number of ultra-wideband (UWB) wireless communication methods that meet the constraints established by the FCC. One UWB communication method may transmit UWB pulses that occupy 500 MHz bands within the 7.5 GHz FCC allocation (from 3.1 GHz to 10.6 GHz). In one embodiment of this communication method, UWB pulses have about a 2-nanosecond duration, which corresponds to about a 500 MHz bandwidth. The center frequency of the UWB pulses can be varied to place them wherever desired within the 7.5 GHz allocation. In another embodiment of this communication method, an Inverse Fast Fourier Transform (IFFT) is performed on parallel data to produce 122 carriers, each approximately 4.125 MHz wide. In this embodiment, also known as Orthogonal Frequency Division Multiplexing (OFDM), the resultant UWB pulse, or signal is approximately 506 MHz wide, and has a 242-nanosecond duration. It meets the FCC rules for UWB communications because it is an aggregation of many relatively narrow band carriers rather than because of the duration of each pulse.

Another UWB communication method being evaluated by the IEEE standards committees comprises transmitting discrete UWB pulses that occupy greater than 500 MHz of frequency spectrum. For example, in one embodiment of this communication method, UWB pulse durations may vary from 2 nanoseconds, which occupies about 500 MHz, to about 133 picoseconds, which occupies about 7.5 GHz of bandwidth. That is, a single UWB pulse may occupy substantially all of the entire allocation for communications (from 3.1 GHz to 10.6 GHz).

Yet another UWB communication method being evaluated by the IEEE standards committees comprises transmitting a sequence of pulses that may be approximately 0.7 nanoseconds or less in duration, and at a chipping rate of approximately 1.4 giga pulses per second. The pulses are modulated using a Direct-Sequence modulation technique, and is called DS-UWB. Operation in two bands is contemplated, with one band is centered near 4 GHz with a 1.4 GHz wide signal, while the second band is centered near 8 GHz, with a 2.8 GHz wide UWB signal. Operation may occur at either or both of the UWB bands. Data rates between about 28 Megabits/second to as much as 1,320 Megabits/second are contemplated. It will be appreciated that the present invention may be employed by any of the above-described UWB communication methods, or by any other UWB communication method yet to be developed.

One or more modulation techniques may be used to carry out the invention. Modulation techniques may be used to transmit data using a single symbol, or pulse, to represent a plurality of binary digits, or bits. This has an advantage of increasing the data rate in a communications system. A few examples of modulation include Pulse Width Modulation (PWM), Pulse Amplitude Modulation (PAM), and Pulse Position Modulation (PPM). In PWM, a series of predefined widths are used to represent different sets of bits. For example, in a system employing 8 different pulse widths, each symbol could represent one of 8 combinations. This symbol would carry 3 bits of information. In PAM, predefined amplitudes are used to represent different sets of bits. A system employing PAM16 would have 16 predefined amplitudes. This system would be able to carry 4 bits of information per symbol. In a PPM system, predefined positions within the pulse timeslot are used to carry a set of bits. A system employing PPM16 would be capable of carrying 4 bits of information per symbol. Communications systems typically employ more than one modulation technique. This has the potential of vastly increasing the data rate of a communications system.

Another type of modulation method is phase modulation (PM). PM is common in carrier-based communications. Two forms of phase modulation include binary phase shift keying (BPSK) and quadrature phase shift keying (QPSK). In BPSK, the phase of a carrier wave can take two values (0 and 180). A 180-degree phase shift in the carrier could signal a change in the data value. Because BPSK systems use two states (0 and 180 degrees) to modulate data onto the carrier, the system is capable of carrying one bit in each time period. In contrast, QPSK systems modulate data onto the carrier by shifting the phase of the carrier in 90-degree increments. QPSK systems are therefore capable of 2 bits of information during the same time period.

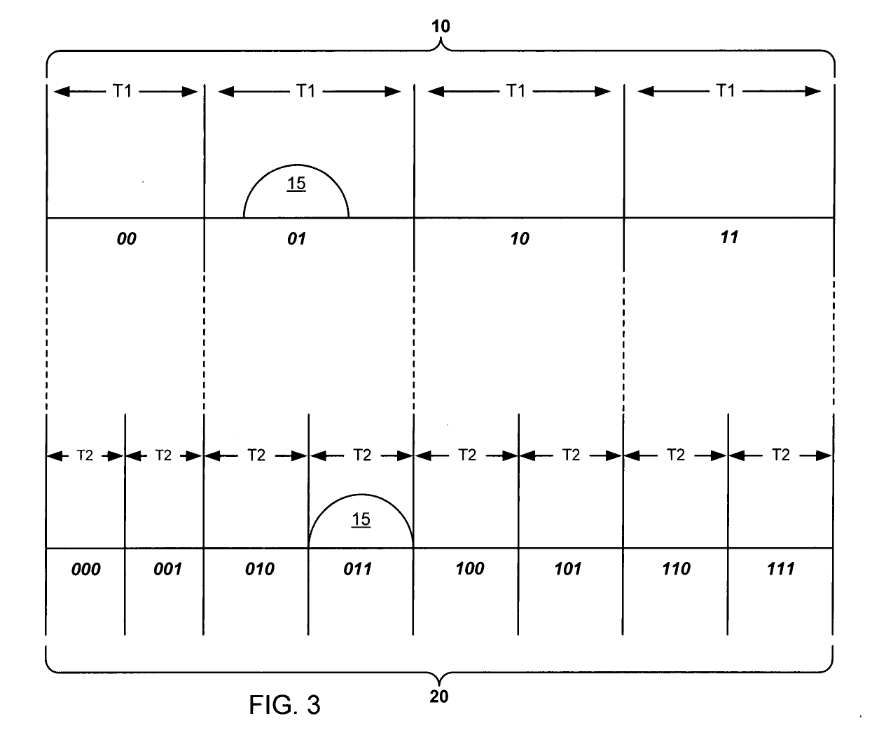

In one embodiment of the present invention shown in FIG. 3, a method is provided that tracks and compensates for the relative timing drift, between communicating devices. One feature of this method is that the time bin resolution can be reduced and the order of modulation can be increased. For example, in a PPM communications system 10, the pulse durations and the time bin spacing, or resolution, may be different. The pulses 15 may be 400 picoseconds and the receiver's time bin spacing T1 may be 800 picoseconds. In system 10 the additional time in bin spacing T1 may be allocated to account for the drift of timing references between devices. As the timing references drift the pulse 15 may arrive at the receiver at a time not precisely expected by the receiver. By employing methods of the present invention, the drift is monitored and compensated for.

In system 20 a shorter time bin spacing T2 is shortened and the order of modulation increased, to three bits where system 10 was capable of two bits.

In another embodiment of the present invention, the receiving device may update its timing reference before receiving another predetermined sequence of bits. In this embodiment once a device receives a predetermined sequence of bits, commonly referred to as a synchronization code or sequence, the timing reference is set to the time of arrival of that sequence. As subsequent UWB pulses 15 arrive at the receiving device, the device determines which time bin the pulse 15 falls within, demodulates the data from the pulse 15, and may then realign the time bin spacing T2 by adjusting its timing reference based on where within the time bin the pulse 15 arrived. This dynamic update of timing may be done on every pulse 15 or alternatively the update may be done on some other periodic basis such as every other pulse 15, every third pulse 15, or when the relative drift exceeds a threshold. For example, a timing reference update may occur when the drift causes pulses 15 to arrive more than 10% off center from the midpoint of the time bin.

In this embodiment, an optional statistics register may be used to track the drift over a number of pulses 15 prior to updating the timing reference. A UWB communication device may calculate a function based on the contents of the statistics register to determine how to adjust the timing reference. For example, the device may average the drift over a number of pulses 15, calculate the median value of drift over a number of pulses 15, or alternatively may calculate a derivative, or rate of change, to determine how fast the drift is changing. In this optional configuration the effects of spurious or instantaneous drift can be minimized. One feature of this configuration is that longer-term drift may be compensated for while short-term drift may be ignored. This allows the device to adjust to trends in the drift while minimizing the short-term effects that may cause the device to over-compensate or under-compensate.

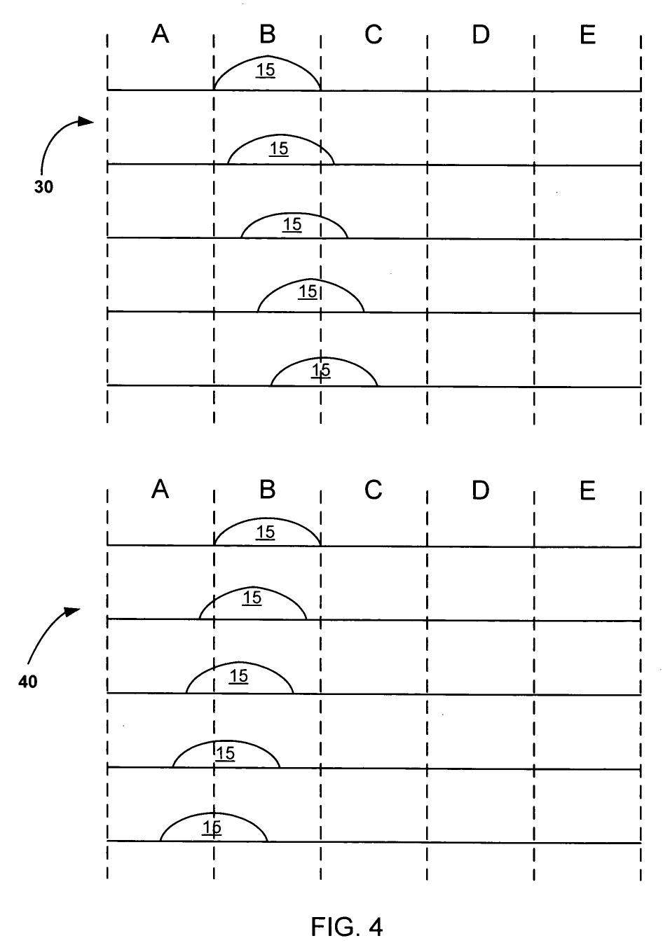

FIG. 4 illustrates the drift of timing references between devices. In example 30 time bins A through E are shown with a pulse 15 may be expected in time bin B. As the timing references between devices drifts the pulse 15 may actually arrive at an ambiguous time between time bins B and C, making the probability of bit error larger. Example 30 illustrates a pulse 15 intended for time bin B arriving at different times until the receiver is confused between time bins B and C. Likewise, Example 40 shows the impact of a relative timing drift in the opposite direction. As the drift continues, the pulses 15 intended for time bin B may be confused for a pulse in time bin A.

Communication systems not employing the present invention may be forced to re-synchronize their devices to a master time reference on a more frequent basis. Since the re-synchronization process involves sending and receiving a sequence of pulses not representing data, the more frequent re-synchronization is performed, the less efficient the communication system is at transferring data. Therefore, one feature of the present invention is that the time period between synchronization may be extended allowing for a more efficient communications system.

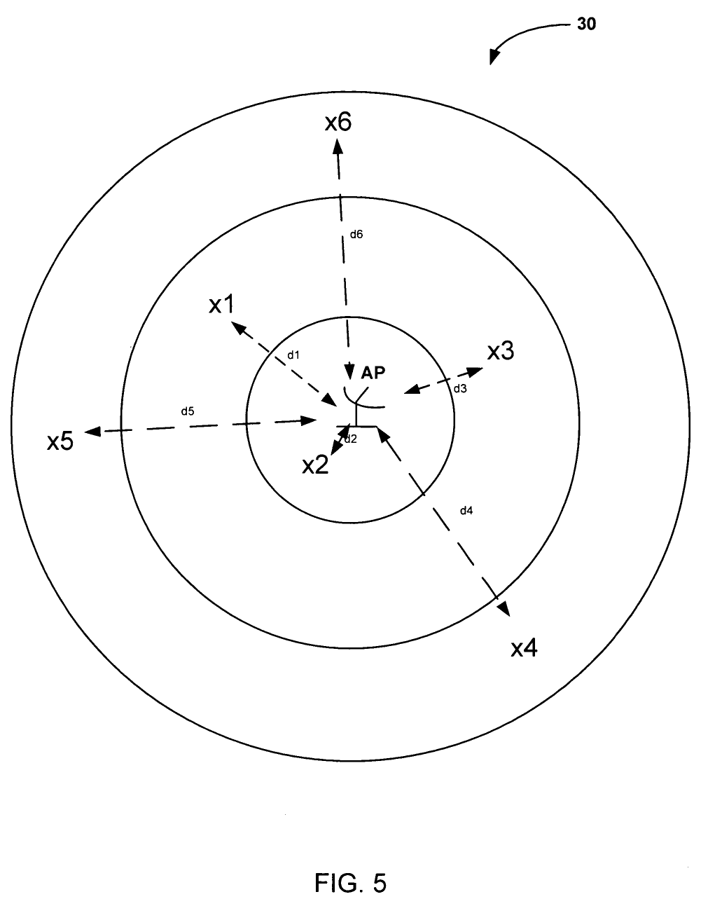

FIG. 5 illustrates a network 40 of UWB devices with a single access point AP, and a number of communication devices X1 through X6. Each communication device X1 through X6 is at a distance D1 through D6, respectively from the access point AP. In one embodiment of the present invention, access point AP tracks and reports clock drift to each device X1 through X6. In this embodiment any one of device X1 through X6 may adjust its timing reference to the timing reference of access point AP. In another embodiment of the present invention access point AP may adjust its timing reference based on information received from any of devices X1 through X6.

One method of the present invention involves the access point AP receiving information about clock drift from a multiplicity of devices X1 through X6. In this embodiment the access point AP may weight the relative information received from the devices X1 through X6 to determine if and in what direction to change its timing reference. For example, the access point AP may weight the information received by the devices by the inverse of the distances D1 through D6 to each of the devices X1 through X6. Additionally, the access point AP may weight the information received by the priority of the communications or the quality of service requirement of each device X1 through X6. After applying the relative weight to each of the devices X1 through X6 drift information, the access point AP may perform a function on the weighted information, or other functions as described above, to derive a timing adjustment. This function may be taking the average of the weighted information, calculating the median of the weighted information, or alternatively may be calculating the sum of the weighted information.

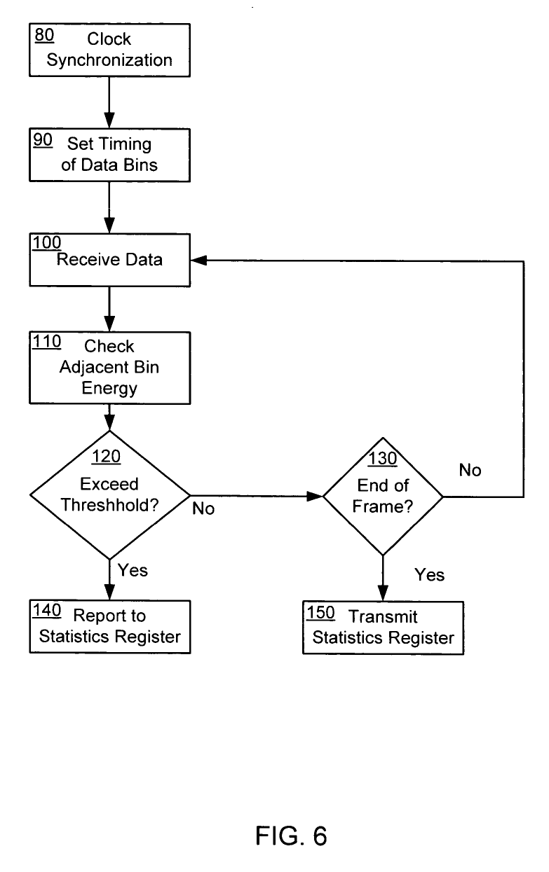

In one embodiment, a receiving device may detect received energy in the surrounding time bins as an indication of the drift of timing references. FIG. 6 illustrates a method for tracking the drift. Each device includes a statistics register, which may track a timing drift and status bits that record changes in drift. In step 80 the receiving device detects a synchronization sequence and synchronizes its timing reference to the transmitting device. In step 90 the device sets the timing of its receive time bins to correspond with the incoming signal. Alternatively, the device may have fixed time bin sizes and step 90 would not be required. In step 100 the device is receiving data from a group of data bits in a frame. In step 110 the receiving device checks the received energy in the time bins adjacent to the bin where the pulse is detected. In step 120 the total energy in each adjacent bin is compared to a threshold value and if the threshold is exceeded, step 140 sends a signal to the statistics register. After receiving the corresponding signal, or alternatively, if the threshold was not exceeded in step 140, then in step 130 if the end of the frame is not reached it returns to step 100 to receive and process additional data. If the receiving device has reached the end of the frame, it transmits the statistics register to the transmitting device in step 150.

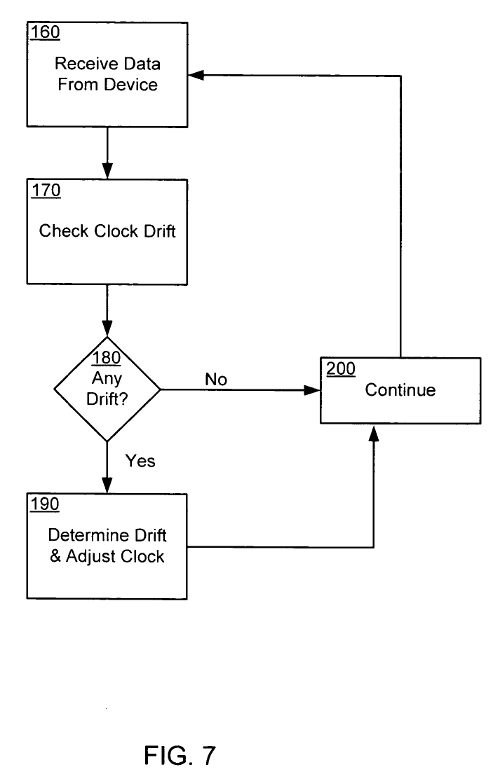

FIG. 7 illustrates a method of the present invention that may be used by a master device in an ad-hoc network or by an access point AP. An ad-hoc network is a temporary network, which may be set up between devices where one of the devices acts as a master device. In step 160 the access point/master device receives an ultra-wideband frame from one or more remote devices. Each of the frame(s) may have information from a statistics register describing clock drift. The access point/master device checks the status of clock drift in step 170. If no clock drift is detected, it goes to step 200 and continues back to step 160. If clock drift is detected, the device goes to step 190, determines the drift and adjusts the timing reference. Step 190 may further comprise calculating a function based on weighted drift information from the communicating devices. The weighting may be based on a number of factors including: distance to the access point/master device; the priority of communications; the type of data being sent; and the quality of service requirement. Additionally, the function may include calculating rate of change by taking a derivative, a summation and/or a mean value. In this fashion timing references can be adjusted without transmitting synchronization codes, thereby increasing the data rate of a communication system.

Thus, it is seen that methods of improving ultra-wideband communications is provided. One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. Many designs other than the above-described embodiments will fall within the literal and/or legal scope of the following claims, and the present invention is limited only by the claims that follow. It is noted that various equivalents for the particular embodiments discussed in this description may practice the invention as well.

What is claimed is:

1. A method of synchronization comprising the steps of:
transmitting an ultra-wideband signal comprising a synchronization sequence from a first device having a first timing reference;
receiving the ultra-wideband signal at a second device having a second timing reference;
synchronizing the second timing reference to the first timing reference based on the time of receipt of the synchronization sequence; and
updating a statistics register on the second device with the time of arrival of the synchronization sequence.

2. The method of claim 1, further comprising the step of calculating a function from the statistics register.

3. The method of claim 2, wherein the function is selected from a group consisting of: a mean function, a median function, a rate of change function, and a sum function.

4. The method of claim 1, further comprising the step of communicating the contents of the statistics register to the first device.

5. The method of claim 1, further comprising the step of adjusting the first timing reference based on the contents of the statistics register.

6. The method of claim 1, further comprising the step of adjusting the second timing reference based on the contents of the statistics register.

7. The method of claim 1, wherein the synchronization sequence is transmitted using at least one discrete pulse of electromagnetic energy.

8. The method of claim 7, wherein the at least one discrete pulse of electromagnetic energy has a duration that can range from between about 10 picoseconds to about 1 microsecond.

9. The method of claim 7, wherein the at least one discrete pulse of electromagnetic energy has a power that can range from between about +30 dBm to about −60 dBm, as measured at a single frequency.

10. A communication network, comprising:
a first device transmitting an ultra-wideband signal; and
at least two receiving devices receiving the ultra-wideband signal, with each of the at least two receiving devices transmitting a statistics register to the first device;
wherein the first device calculates a timing reference adjustment from the received statistics registers.

11. The communication network of claim 10, wherein the calculation of a timing reference adjustment further comprises weighting a contents of each statistics register by a parameter and calculating a function on the weighted statistics.

12. The communication network of claim 11, wherein the parameter is related to a data rate required by at least one of the at least two receiving devices.

13. The communication network of claim 11, wherein the parameter is related to a distance between at least one of the receiving devices and the first device.

14. The communication network of claim 11, wherein the parameter is related to a quality of service requirement of at least one of the receiving devices.

15. The communication network of claim 11, wherein the function is selected from a group consisting of: a mean function, a median function, a rate of change function, and a sum function.

16. The communication network of claim 10, wherein the first device makes an adjustment to its timing reference based on the calculated timing reference adjustment.

17. The communication network of claim 10, wherein the ultra-wideband signal is transmitted using at least one discrete pulse of electromagnetic energy.

18. The communication network of claim 17, wherein the at least one discrete electromagnetic pulse has a duration that can range from between about 10 picoseconds to about 1 microsecond.

19. The communications network of claim 18, wherein the at least one discrete electromagnetic pulse has a power that can range between about +30 dBm to about −60 dBm, as measured at a single frequency.

20. A method of synchronization comprising the steps of:
transmitting an ultra-wideband signal comprising a synchronization sequence from a first device having a first timing reference;
receiving the ultra-wideband signal at a second device having a second timing reference;
adjusting the second timing reference using the synchronization sequence; and
adjusting the second timing reference before receiving another synchronization sequence.

21. The method of claim 20, wherein the adjustment of the timing reference is done on a pulse-to-pulse basis.

22. The method of claim 20, wherein the adjustment of the timing reference is done on a greater than a pulse-to-pulse basis.

23. The method of claim 20, wherein the adjustment of the timing reference is done in response to exceeding a threshold in timing reference drift.

24. The method of claim 20, further comprising updating a statistics register on the second device and wherein the adjustment of the timing reference is based on calculating a function where the contents of the statistics register is an input to the function.

25. The method of claim 24, wherein the function is selected from a group consisting of: a mean function, a median function, a rate of change function, and a sum function.

26. The method of claim 20, wherein the ultra-wideband signal is transmitted using at least one discrete pulse of electromagnetic energy.

27. The method of claim 26, wherein the least one discrete electromagnetic pulse has a duration that can range from between about 10 picoseconds to about 1 microsecond.

28. The method of claim 26, wherein the at least one discrete electromagnetic pulse has a power that can range from between about +30 dBm to about −60 dBm, as measured at a single frequency.
